(19) United States
(12) Patent Application Publication
(10) Pub. No.: US 2015/0059289 A1
(43) Pub. Date: Mar. 5, 2015

(54) BLENDING APPLIANCE FOR ENHANCING PRODUCT FLAVOR AND SHELF LIFE

(71) Applicant: FreshBlender, LLC., Austin, TX (US)

(72) Inventor: Trace Cody, Austin, TX (US)

(21) Appl. No.: 14/470,466

(22) Filed: Aug. 27, 2014

Related U.S. Application Data
(60) Provisional application No. 61/870,308, filed on Aug. 27, 2013.

(51) Int. Cl. A23B 4/16; A47J 43/07

(52) U.S. Cl. CPC A23B 4/16; A47J 43/07; A23V 2002/00
USPC 53/432; 99/467; 426/519

(57) ABSTRACT

An appliance and method for increasing the flavor and shelf life of a blended food product by purging the air from the airspace surrounding the food product and replacing the air with another gas such as carbon dioxide that is compatible with food preparation and reduces the oxidation that the food product undergoes in the normal blending process.

### CROSS-REFERENCE TO RELATED APPLICATIONS

This application claims the benefit of U.S. Prov. Appl. 61/870,308, filed 27 Aug. 2013, which is incorporated herein by reference.

### BACKGROUND

Blenders have become an increasingly common kitchen appliance for homes and food/beverage businesses alike. Blenders allow the fast production of smoothies, cocktails, purees, soups, juices, condiments, sauces, baby food, nut butters, and many other foods. A blender is generally a small electric appliance that has a carafe and a lid to hold food product(s) to be blended. The carafe generally contains a blade, or set of blades, that is attached the bottom of the carafe. The carafe is usually filled with the food product and then set atop a base containing a motor with a vertical shaft used to rotate the blades. When rotated, the blades of the blenders and other blending appliances are designed to reduce food products into smaller and smaller pieces. Thus, the proportion of surface area of the food product is greatly increased during the blending process.

There are many commercially available blenders today offering a wide array of features. To operate these features, blenders may have user control knobs and switches to control features, such as blade speed and programmed blending cycles. Blenders may also include large-capacity carafes, high-power motors, specially designed blades, and tampers to push products into the blades.

Other blending appliances, such as food processors and juicers, also perform a similar function to the traditional blender. Food processors are commonly used in food preparation to blend, grind, shred, and puree food items. Food processors, though, generally have a shorter and wider carafe and may have removable or interchangeable blades. Likewise, many juicers operate in a similar fashion by chopping up fruits, vegetables, greens, etc. and separating the resulting juice from pulp. Other juicers squeeze or compress the products in order to produce juice.

However, the blended food products using such blenders, food processors, and juicers may quickly degrade in viability, flavor, and nutrient content. In fact, the inventor has noticed that there are certain food products that make use of a blending appliance undesirable because the food products tend to go rancid before they can be consumed. Therefore, there is a need for an improved blender that improves the flavor, nutrient content, and shelf life of blended drinks and food products.

### BRIEF DESCRIPTION OF THE DRAWINGS

FIGS. 1a-1d are different views of a base of a blending device according to the present disclosure.

FIGS. 2a-2c are an elevation view, a cross-sectional view, and a detailed view of a base and a carafe of the disclosed blending device.

FIGS. 3a-3b are an elevational view and a cross-sectional view of a base and carafe of the disclosed blending device.

FIG. 3c is a cross-sectional view of a blending device lid.

FIGS. 4a-4b are different views of a carafe insert.

FIG. 4c is a cross-sectional view of a blending device with a carafe insert.

FIGS. 4d-4e are detail views of the blending device in FIG. 4c.

FIGS. 5a-5c illustrate a perspective view, a cross-sectional view, and a detailed view of a blending device carafe.

FIGS. 6a-6c illustrate an elevational view, a top view, and a cross-sectional view of a blending carafe with purging lid.

FIGS. 6d-6e are detail views of the carafe and lid in FIG. 6c.

FIG. 7a is a perspective view of an embodiment of a blender with a purge system mounted to the carafe.

FIG. 7b is a perspective view of an embodiment of a carafe.

FIG. 7c-7d are front and side views of an embodiment of a blender with a purge system mounted to a carafe.

FIGS. 8a-8d are different views of an embodiment of a blender base.

FIG. 9a is a top view of a carafe.

FIG. 9b is a cross-section of a carafe of FIG. 9a.

FIG. 9c is a partial front view of a carafe and FIG. 9d is a cross-section therefrom.

FIGS. 10a-10e are a top view, a cross-section, a detail view, a front view, and a bottom view, respectively, of a carafe shell.

FIGS. 10f and 10g are a cross-section and detail view of a carafe shell, respectively.

FIGS. 11a-11e are a front view, a cross-section view, a detail view, a bottom view, and a plan view of a purge system housing.

FIGS. 12a-12d are a plan view, a front view, a detail view, and a bottom view of a carafe insert.

FIGS. 13a-13c are a perspective view, a side view, and a cross-section view of a standalone lid.

FIGS. 14a-14d are a side view, a bottom view, a cross-section view, and another cross-section view of a main body of a standalone lid.

FIGS. 15a-15c are a side view, a bottom view, and a detail view of a mating flange of a standalone lid.

FIG. 16 is a schematic of an embodiment of a controller for use with any one or more of the disclosed embodiments.

### DESCRIPTION

The inventor has discovered that the propensity for food and beverage products (“food product”) to deteriorate is a direct result of the product's level of oxidation. This oxidation can be observed not only in how quickly the blended food product can deteriorate, but also in the flavor of the blended food product. Due to the rapid movement of the blades and high amount of chaos and turbulence created during the blending process, oxidation of the food product is increased.

Since a blender is designed to reduce food products into smaller and smaller pieces, the proportion of available surface area of the food is maximized through the process. If already liquid, or as the food product slurries or becomes more fluid, vortexes may form during the mixing process introducing more of the product to the surrounding air. Through such rapid mixing, the exchange of air with food components ensures that many, if not all, volatile compounds in the food will be destroyed through oxidation. These volatile compounds can include polyunsaturated fats, such as Omega-3, and essential fatty acids. Other oxygen-sensitive products include, but are not limited to, many B vitamins, biotin, and especially antioxidants, which will combine with the oxygen in the air and render the antioxidant property less nutritionally effective once it has been consumed.

Disclosed herein is an improved blending appliance and method for purging the air from the airspace above and/or surrounding the food product in the appliance's carafe or container, and replacing the air with another gas that is compatible with food preparation and greatly reduces the oxidation that the food product undergoes in the blending process. Such purged blending increases the flavor, nutrient value, and shelf life of the blended food product.

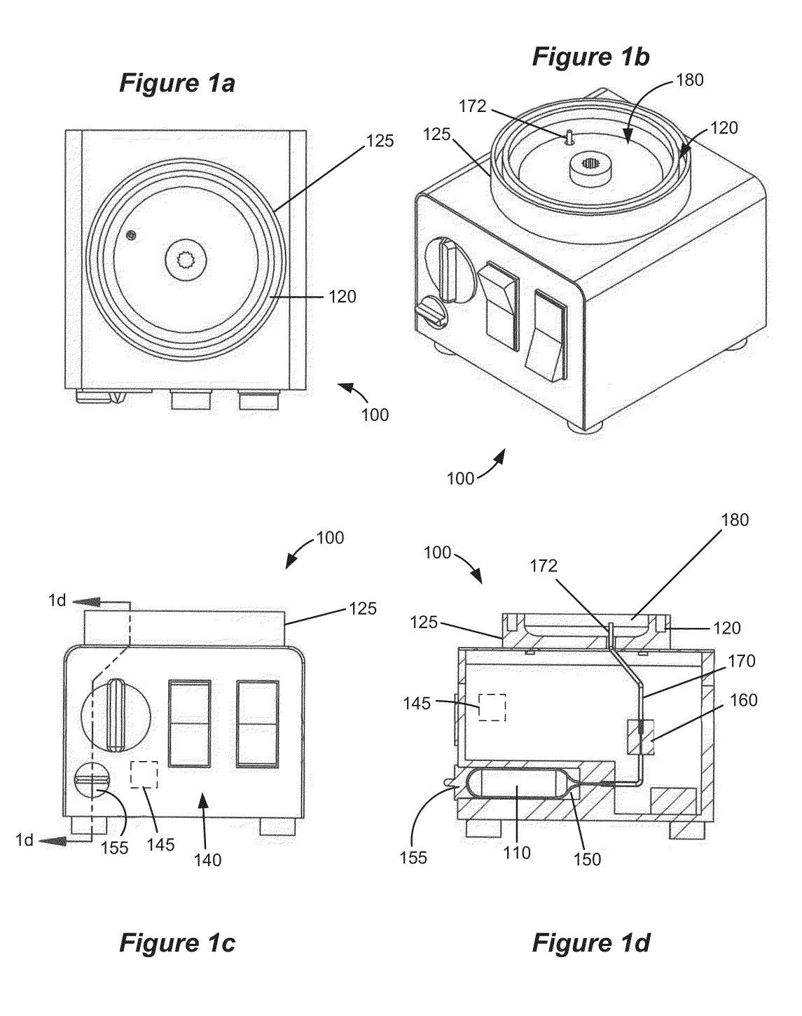

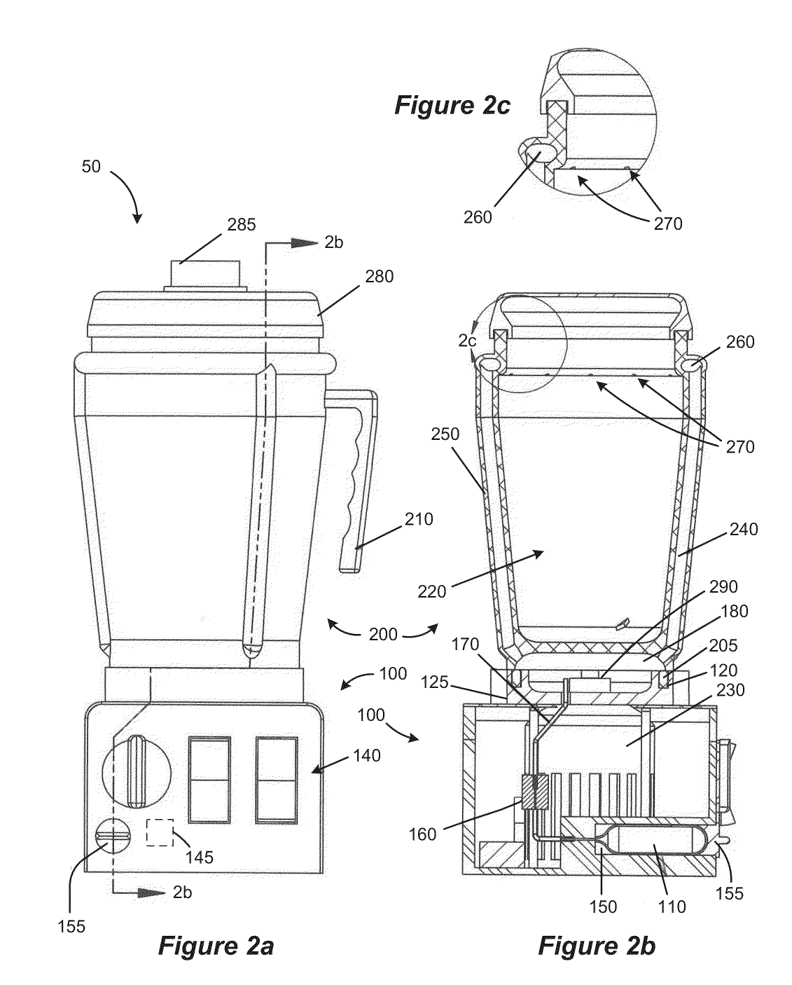

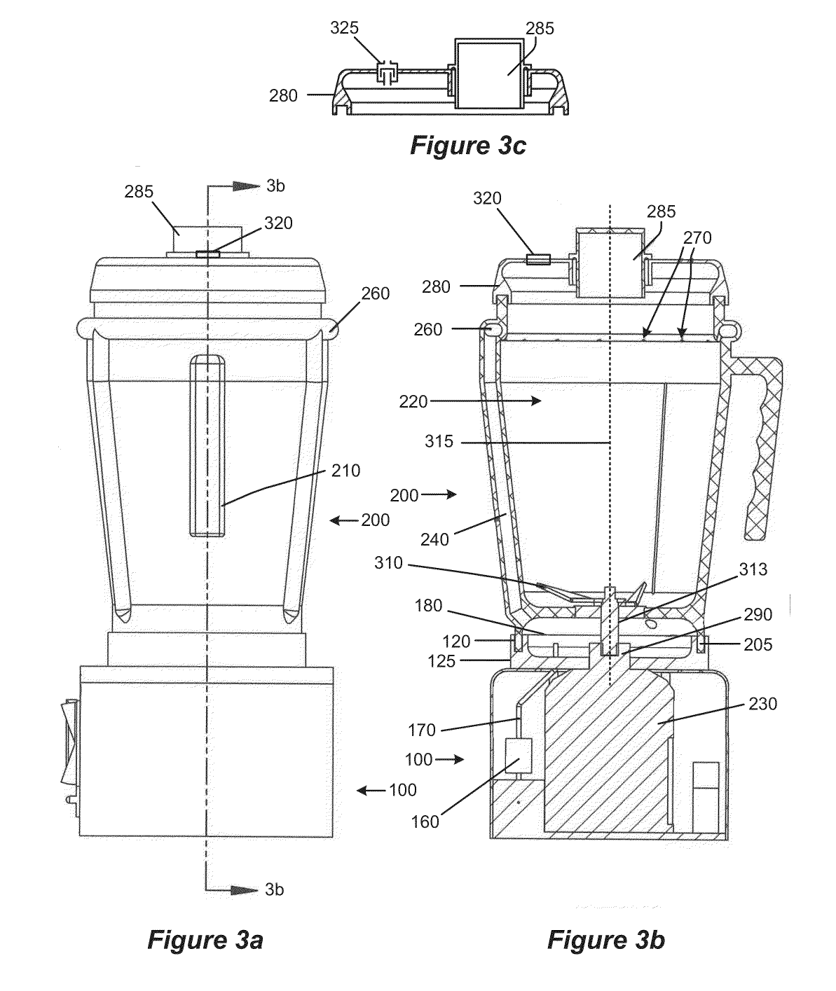

FIGS. 1a-1d show an embodiment of a blending appliance having a body (base 100) according to the present disclosure. FIGS. 2a-2b show a front view and a side cross-sectional view of the base 100 having a carafe or container 200 for the disclosed blending appliance 50. FIG. 3a shows another side view of the base 100 connected to the carafe 200, and FIG. 3b is the associated cross-section of FIG. 3a and additionally shows a blade 310 that spins about the centerline 315 of the carafe 200. The blade 310 is connected to a coupler 290 by a shaft 313.

The blending appliance 50 can be a blender, food processor, juicer, or any other comparable food and/or beverage appliance. Though not so limited, for simplicity, the appliance 50 may be referred to as a blender as discussed herein. As will be appreciated by one skilled in the art, however, variations in blades, motor, carafe size, and the like can be made without departing from the present disclosure.

As shown, the blending appliance 50 comprises two main subassemblies: the base 100 and the carafe 200. Turning first to the discussion of the base 100, the base 100 comprises a blender motor 230, controller 145 having user controls 140, and other components (voltage regulators, motor cooling fan, wiring, controllers, etc.), which are not shown for clarity. The base 100 may contain a sealable gas port 150 with a gas source connection. Though shown as an electric controller, controller 145 may be a physical control comprising switches either manually or electrically controlling valves or solenoids for example.

As shown in FIG. 1d, where the user may install a source (e.g., a cartridge 110) of compressed or pressured gas (e.g., carbon dioxide “CO₂”) for blending. Other gases compatible with food use, such as nitrogen or other inert gas, can also be used as the blending gas. The cartridge 110 may be comparable to CO₂ cartridges used in bike tube fillers, air guns, and CO₂-propelled pinewood derby cars. The cartridge 110 may be connected to the port 150 by a gas source connection such as threads on the end of the cartridge 110, by a compression fitting, or by some other method known in the art. The gas port 150 connects to a valve or valve solenoid 160, which controls when the gas can flow. Various filters, valves, tubing connections, and the like may be provided as necessary.

The gas port 150 may be accessed by a gas port retainer 155 that may be used to secure the gas cartridge 110. The retainer 155 may be a friction, threaded, or press-and-turn type fitting. Additionally, the retainer 155 may be a watertight connection. For example, the retainer 155 can screw into the base 100 by a threaded connection. Any other suitable fitting can also be used to secure or access the cartridge 110.

In some embodiments, instead of a removable cartridge 110, the port 150 is replaced with a gas source connection such as a threaded connection, compression fitting, or quick-disconnect fitting for an external gas supply, such as a nitrogen gas or CO₂ supply line or larger industrial gas tank (not shown). The port 150 may also be fitted with various adapters to use other commercially available blending gas sources, for example, the CO₂ bottles from Soda-Club or Soda Stream. Some embodiments may have a pressure regulator (not shown) built into the base 100, while others may simply require the user to limit the pressure of the connected line. In addition to the front, the connection may also be located on any side of the base 100.

The solenoid 160 may be controlled manually (e.g., by one of the controls 140), controlled with a purging timer (not shown), or triggered by the user controls 140 to determine how long the gas should be delivered in order to purge the blender carafe 200. Tubing 170 connects the solenoid 160 to a mount 125 on the top of the base 100. As shown in FIG. 2b, the carafe 200 installs on the base's mount 125 in a fixed manner so as not to rotate. Various flanges, ribs, or other features can be provided on the mount 125 and the bottom of the carafe 200 to achieve such a fixed mounting. When the carafe 200 installs on the mount 125, a passage 180 can be formed between the base 100 and the bottom of the carafe 200. The tubing 170 may have a protrusion 172 extending the tubing 170 into the passage 180. In some embodiments, there need not be such a passage 180 because the carafe 200 and/or base 100 can comprise a poppet valve (not shown), a fitting, or the like that fits directly over the protrusion 172 to receive the blending gas.

A restrictive orifice (not shown) may be installed in-line between the gas inlet and line outlet of the passage 180 in the carafe base 100 for factory-calibrating the purging timer. The orifice would restrict the flow, and as the blender 50 monitors the gas source pressure, the controller 145 in the blender can adjust its timers for how long to purge (lower pressure means longer cycles, but highly-optimized cycles for the life of the canister) and limit the flow rate of the gas into the carafe 200. As one skilled in the art will recognize, pressure vs. flow across the orifice may influence or determine the purge cycle.

Turning now to more details about the carafe 200, FIG. 2a shows the carafe 200 connected to the base 100. FIG. 2b is a cross-sectional view of the blender 50 in FIG. 2a. The carafe 200 may be connected to the base 100, at least in part, by a bottom lip 205 that fits within the a slot 120 of the base's mount 125. In one embodiment, the connection forms the passage 180, discussed above, which is used to transport the gas. This passage 180 can be sealed using various seals (not shown) between the bottom lip 205 and the base's mount 125.

The carafe 200 can comprise a handle 210 for transporting the carafe 200, a blending cavity 220 for holding the food product to be blended, and a lid 280 with an ice port 285 for enclosing the blending cavity 220. Unlike a conventional blender carafe, this carafe 200 has gas channels 240 that can be formed into the carafe's wall(s) 250. In other embodiments disclosed herein, gas channels 240 can be formed in other parts of the carafe 200, such as in the handle 210, or the carafe 200 can include dual walls with an annulus therebetween providing the channel.

The channels 240 can connect the passage 180 at the blade coupling 290 to a hollow rim 260 that can run along the top of the carafe 200. The hollow rim 260 can comprise small holes 270, slits, or the like that are formed or drilled into it. The holes 270 allow the blending gas to enter the cavity 220. The holes 270 may also be used to aim inside of the cavity 220 and point down towards the bottom of the cavity 220. The rim 260 may run at least a portion of the top circumference of the carafe.

Other features can be used to introduce the gas from the channels 240 into the cavity 220 rather than such a rim 260. In general, the channels 240 may simply have outlets defined at the top of the carafe's cavity 220. These outlets can have nozzles or valves to prevent entry of air and food product back into the channel. Such outlets can also be formed along the channels 240 at any suitable point in the cavity 220.

Additionally, the carafe 200 is shown as a unitary component from the bottom end to the top end. It will be appreciated that the bottom end of the carafe 200 may actually comprise a removable blade unit that threads and seals in place on a lower part of the carafe 200. Such a removable blade unit would be adapted to communicate the blending gas from the base 100 to the channels 240 on the carafe 200, yet would be removable to allow the blades to be removed, cleaned, or replaced as needed.

Upon starting a purged blending cycle, the blender 50 can open the solenoid 160 for a certain period of time (e.g., a few seconds). The gas from the cartridge 110 or other source then runs from the port 150, through the tubing 170, and out into the passage 180 beneath the carafe 200 where the channels 240 guide the gas via positive pressure to the top connecting rim 260 on the carafe 200. Reaching the top rim 260, the gas can then pass out of the small holes 270 around the rim 260 that may point down inside the blender cavity 220. Internally, the rim 260 may have a flap or valve feature to allow gas from the channels 240 to enter the rim 260 but prevent reverse flow. The blending gas in the blending cavity 220 that is heavier than air like CO2, can form a blanket on the food product in the blender 50, displacing or lifting the air in the carafe 200 as it does so.

In other embodiments, the channels 240 may also run to the bottom of the cavity 220 to bubble the blending gas up from the bottom of the cavity 220 thus lifting the still air in the cavity 220. The channels 240 may also run from the passage 180 to the rim 260 and back down to the bottom of the cavity 220. In embodiments where the blending gas enters the carafe 200 through the bottom, the gas will bubble up through the food products, and then slowly purge out any air as the gas accumulates inside of the carafe 200. Additionally, a larger volume of blending gas may be used to assist in purging the blending cavity 220. This may be advantageous when using blending gases that are lighter than air, e.g., helium or nitrogen gas.

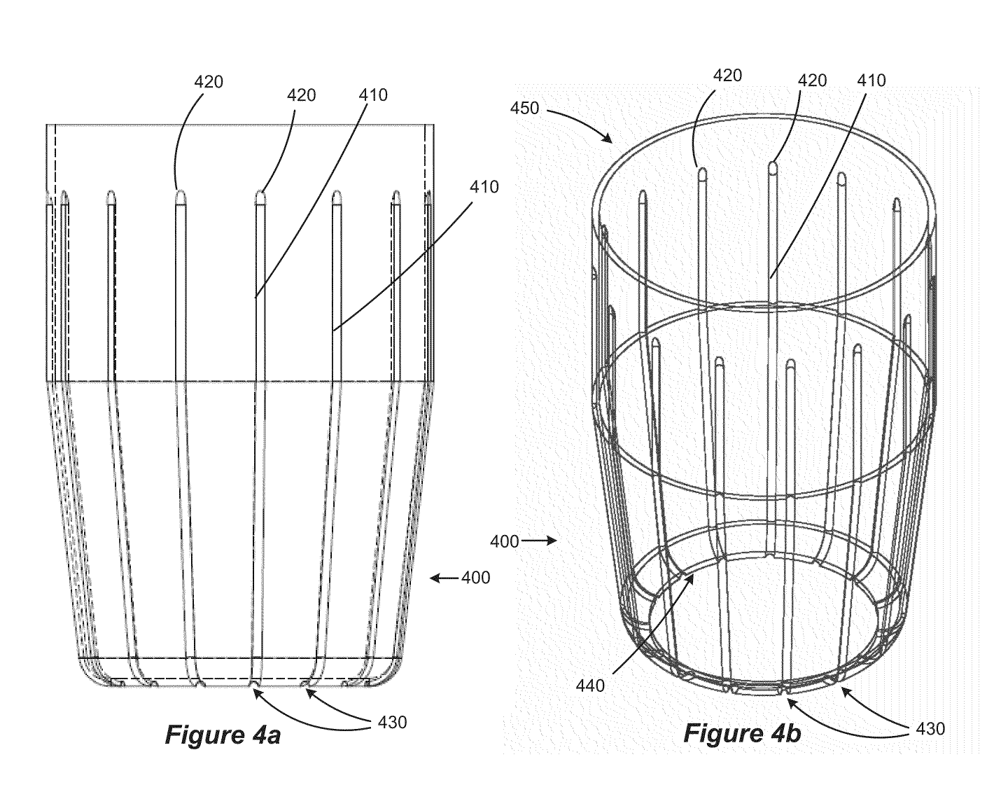

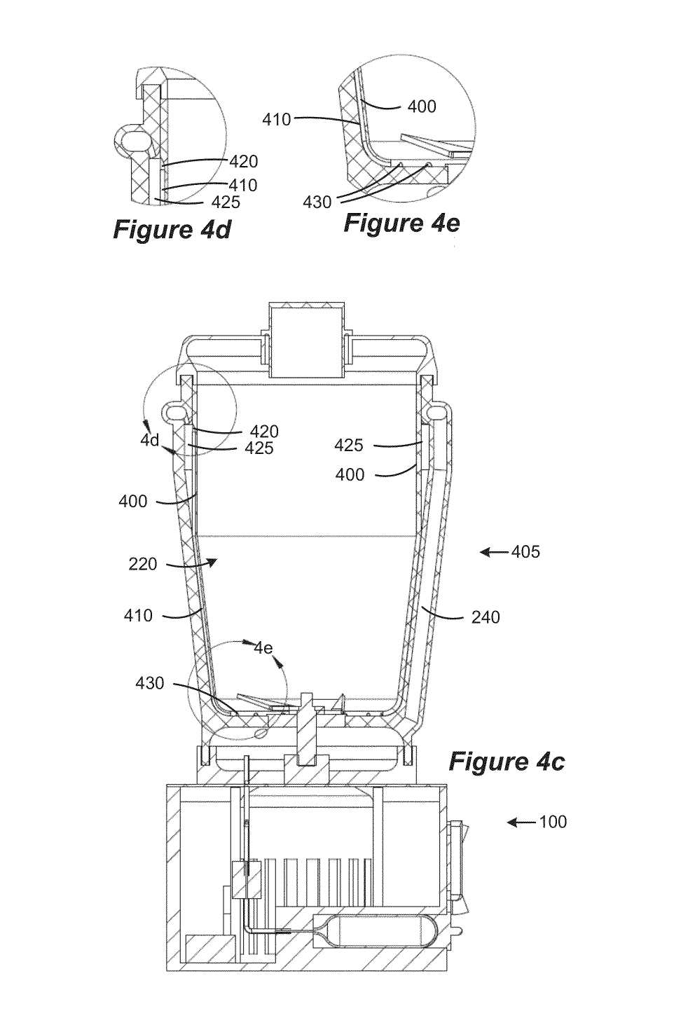

Other embodiments could also comprise an insert 400 as shown in FIGS. 4a-4b allowing an easy way to provide the bottom purging as described above. The insert may be held in place by various means; for example, the insert 400 may snap-in, clip-in, or be held in place by friction. As shown in FIGS. 4c-4e, the insert 400 may be made to be form-fitting with the interior walls of carafe 200 and have channels 410 that may run from a passage 425 formed in the top of the carafe 200 to the bottom of the carafe 200 to allow the blending gas to go to the bottom of the carafe cavity 220 through exit orifices 430. The channels 410 may comprise protrusions or ridges that are formed on the inner face of the insert 400 to direct the food product during the blending process. For example, swirl-shaped protrusions on the internal face of the insert 400may help guide food downward more forcefully, while hard ridges on the internal face of the insert 400 may be good for pushing ice to the middle where it can fall to the blade 310.

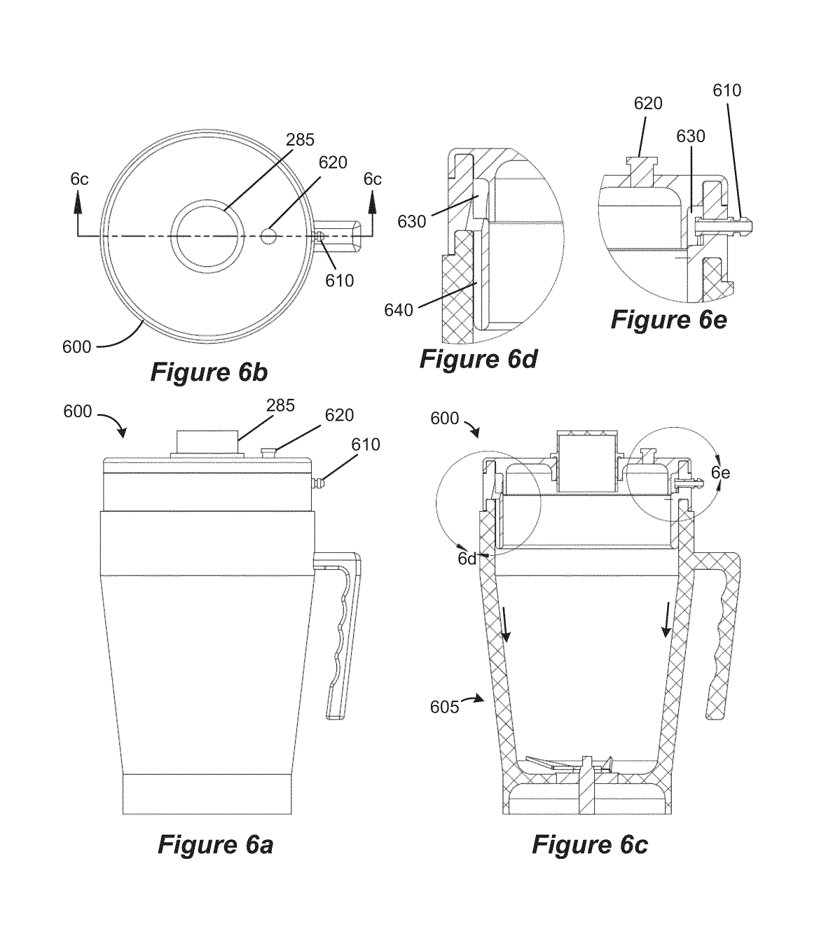

In one embodiment, the insert 400 is keyed to the carafe 200 such that the top of the insert channels 420 align with the gas exit holes 270. The bottom 440 of the insert 400 may be open such that that it can fit easily over the blades 310. The insert 400 may easily pop out of the carafe 200 for easy washing, this also decreases the likelihood that food product will clog the gas exit holes 270 molded into the carafe 200, 405. The insert may also be used with other types of carafes. For example, an insert 400 may be used to retro-fit an older style blender carafe when equipped with a method to connect a purge gas source such as the purging lid 600 as described in further detail with respect to FIGS. 6a-6e.

Although certain embodiments use internal tubing (e.g., 170) and channels (e.g., 180) to deliver the blending gas, some embodiments, the gas delivered from the base 100 may be conducted using external or internal tubing (not shown) rather than integrated channels and tubing on the carafe 200 and base 100. This tubing can connect in various ways to the gas from the solenoid 160 in the base 100 and can be connected to or held on the carafe 200 internally or externally using various techniques. For example, one simple technique for purging the blending cavity 220 for blending is to use a CO2 tank with a flow regulator and a hose. The CO₂ is turned on to develop positive pressure which prevents back flow of food products, e.g., yogurt and the like, and the hose is run to the bottom of the blending cavity 220. Depending on the flow rate, size of the carafe, etc., the cavity 220 may be purged for several seconds, e.g., seven seconds, the hose removed and blending commenced. In the previous example, the ice port 285 may be used to run the hose into the carafe. This provides a suitable exit for the air that is being lifted out and a small area is disturbed when the ice port lid is replaced. Thus, a maximized amount of CO₂ is retained within the carafe 200.

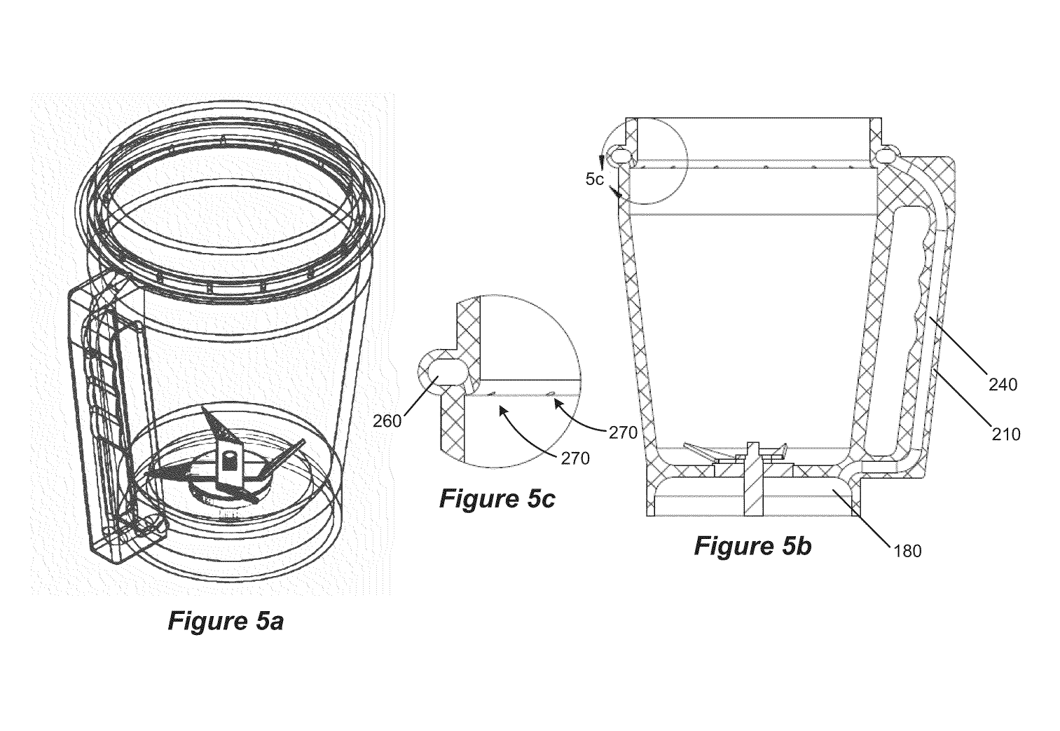

Other techniques can be used to deliver the blending gas from the base 100 to the cavity 220. For example, FIGS. 5a-5c show an embodiment where the handle 210 serves to provide the channel 240. The handle 210 may be connected to the passage 180, or to the tube (170; FIG. 2b) or may be outfitted with a gas connector (not shown) to allow the blending gas to be supplied from an external source. The handle 210, in that embodiment, could be connected directly to the upper portion of the cavity 220 or could be connected to the hollow rim 260.

As opposed to delivering the blending gas to the cavity 220 using features associated with the carafe 200 itself, a body in the form of a lid for the carafe 200 could be used instead. For example, FIGS. 6a-6e show an embodiment with a purging lid 600 for the disclosed body of the appliance. The lid 600 may be used with a non-purging carafe or container 605, in other words, the lid 600 may be used to retro-fit a customary commercially available blender with its own carafe. The lid 600 may have a gas connection 610 which supplies a passage to a chamber 630 connected to an inner lip passage 640. The inner lip passage 640 may be deep enough to promote laminar flow of the blending gas into the carafe 605. The laminar flow may be seen by the arrows in FIG. 6c. This allows the blending gas to “slide” down the inner wall of the carafe helping to lift out the ambient gas, i.e., air, rather than mixing it. A valve 620 may also be included in the purging lid to prevent excess pressure from building up and to provide an outlet for the ambient gas.

Food products may also benefit from being blended in a slightly pressurized environment, for example, up to 15 psig. A metal or thick polymer carafe 200, 605 with a relief valve 320, 620 on a threaded or locking lid 280, 600 may be used for this purpose. The blender may have pressure-rated bearings and safety features similar to a pressure cooker such as an over pressure plug or a lock to prevent opening the lid while the carafe is under pressure.

As shown in FIG. 3b, for example, a relief valve 320 on the top of the lid 280 can be used to control or limit the pressure in the carafe 200. In other embodiments, a gas labyrinth seal 325, as shown in FIG. 3c, may be integrated into the lid 280 to allow the air to vent out without resistance while not allowing food product to escape while blending. This type of seal may be advantageous for use with any blending gas lighter than air, e.g., nitrogen, without allowing the outside air to come back in, even though it may be heavier than the blending gas alone. Sensors, such as a pressure transducer, a weight scale, or a displacement sensor (not shown) can couple to the controller 145 to control the solenoid 160 so that only enough gas is used to displace the air space (also known as head space) in the carafe 200. This would maximize the number of purged cycles the blending appliance 50 can run on a single cartridge 110. This is of less concern with a large supply of gas, such as an industrial bottle or building supply line.

As noted above, the blending appliance 50 uses a blending gas during blending to improve the longevity, flavor, and nutrient content of blended food. Additionally, the purged blending appliance 50 can also be used to produce sparkling foods, drinks, and treats. To that end, the appliance 50 can be operated with a purge cycle comprising purging and then blending. The purge cycle may be accomplished by activating a single control 140 or by performing separate steps. When the purge cycle is run and the cavity 220 is purged with CO2 or other blending gas (though the entire blending cavity 220 need not be completely purged), the blending process that follows allows extensive exposure of the blended product with the gas. The solubility of a gas such as CO₂ in water is much higher than air. Hence, it will provide an effect similar to that of making still water sparkling. Additionally, any vortex that is formed in the blender 50 provides a good interface to constantly release air from the food product and induce the gas inside of the blender's cavity 220. This effect also increases the acidity of the food product due to the formation of carbonic acid. Thus, carbonated cocktails and sparkling smoothies are new food products able to be achieved with the purged blending appliance 50. Cooks and chefs may also wish to use the purged blender with CO₂ gas to enhance a food product that would benefit from increased acidity. For example, purged blending can substitute for the addition of an acid, for example vinegar or citrus juice, in a recipe.

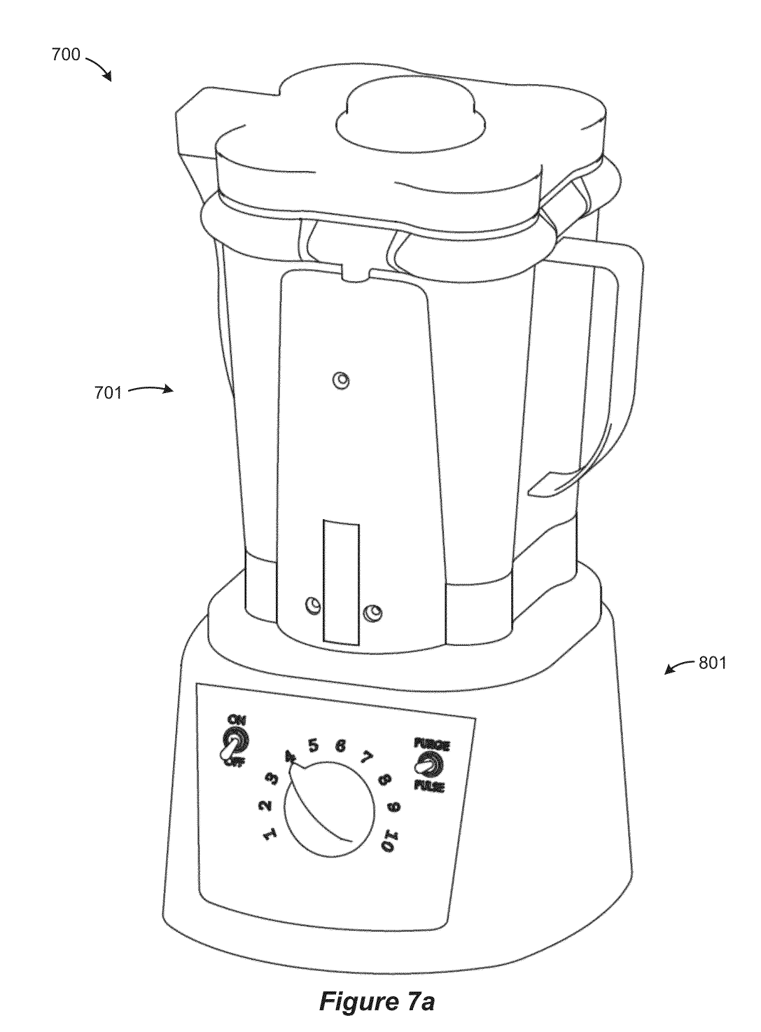

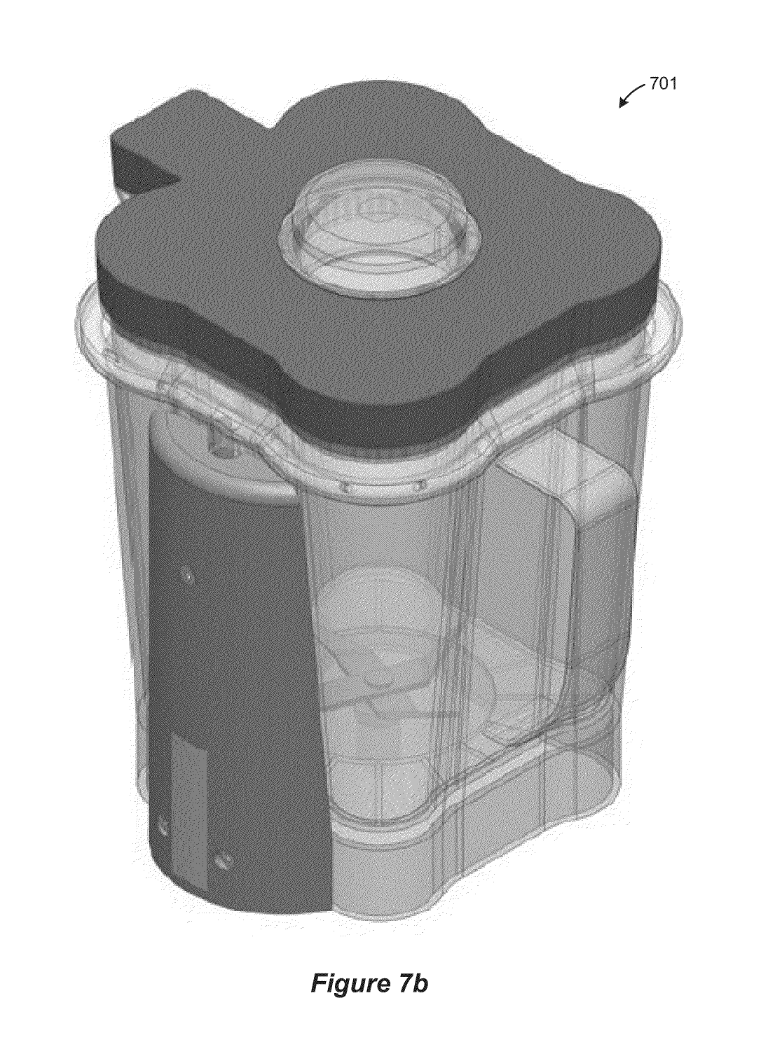

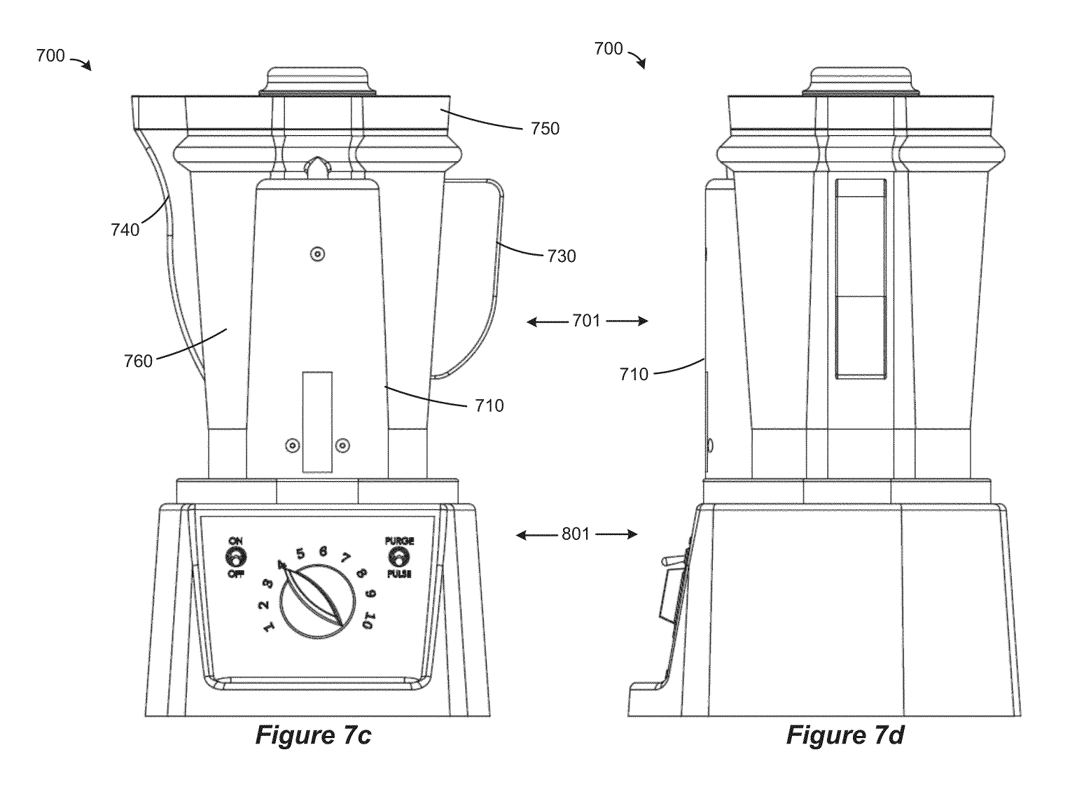

In previous embodiments, many features of the blender 50 have been incorporated into the base. However, another embodiment of a purged blender 700 shown in FIGS. 7a through 9d can incorporate some of the features elsewhere. In this embodiment, the blender 700 may consist of two sections: a carafe 701 and a base 801. FIG. 7a shows a perspective view of the carafe 701 on the base 801, while FIG. 7b shows a perspective view of the carafe 701. Additionally, FIGS. 7c-7d show different side views of the carafe 701 on the base 801.

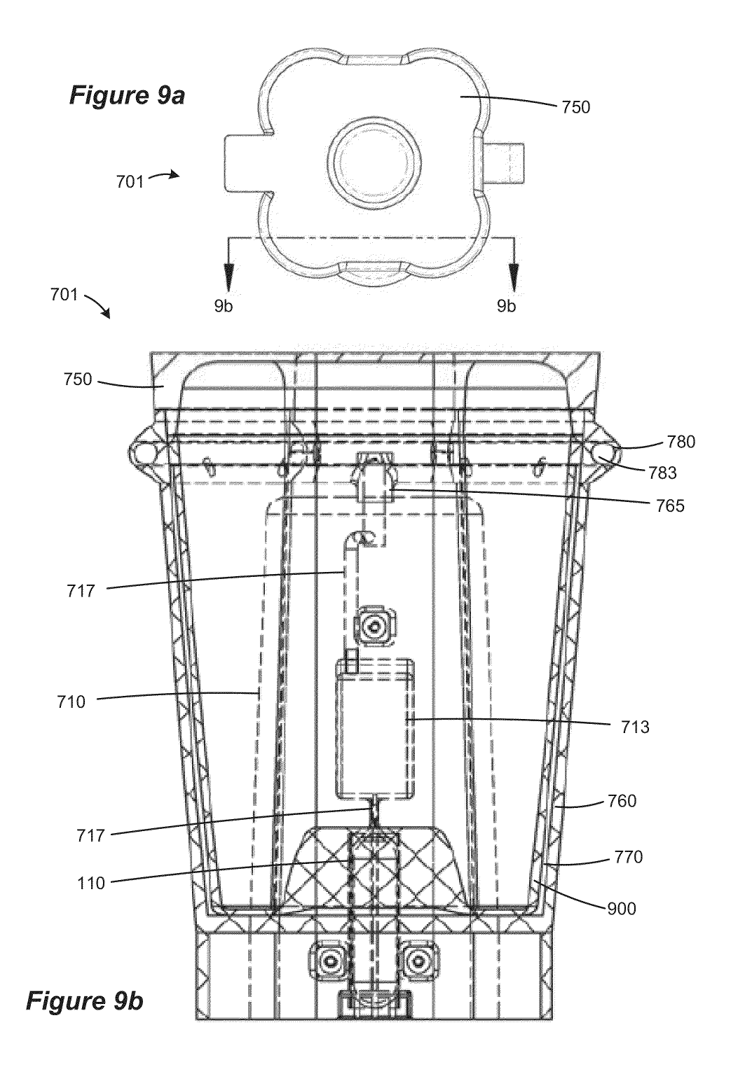

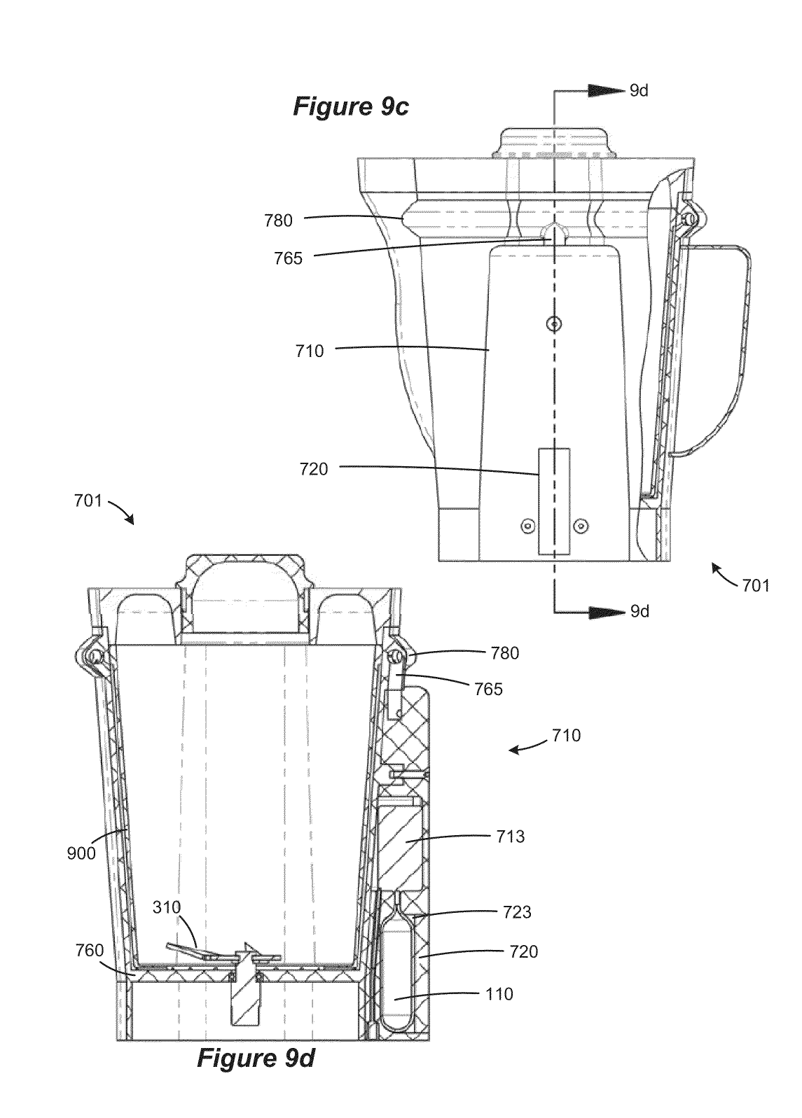

As shown in FIG. 7c, the carafe 701 comprises a shell 760, a lid 750, a pour spout 740, a handle 730, and a purge system body or housing 710. In this embodiment as discussed in more detail below, the carafe 701 holds the blending gas canister (110; See FIG. 9d) in the purge system housing 710 disposed on the carafe 701, rather than the base.

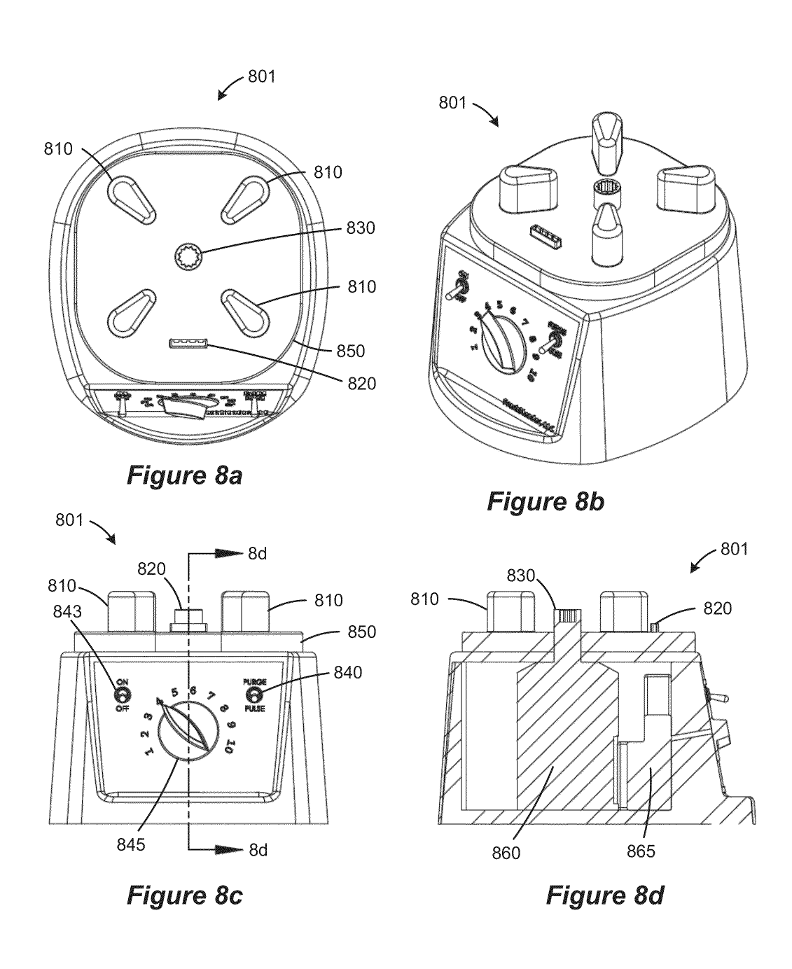

The base 801, which is shown in FIGS. 8a-8d, comprises a carafe mount 850 which has mount columns 810 that support the carafe shell 760. Control inputs on the base 801 control various functions of the blender 700. For example, an on/off switch 843, a purge switch 840, and a speed control knob 845 are used to control power to the blender 700, purging of the carafe 701, and the speed of a motor 860 respectively. The motor 860 is controlled by motor controls 865 connected to the motor control switches in the base 801, e.g., the on/off switch 843 and the speed control knob 845. The motor 860 is also connected to a shaft coupling 830 that turns the blades (310; See FIG. 9d) of carafe 701.

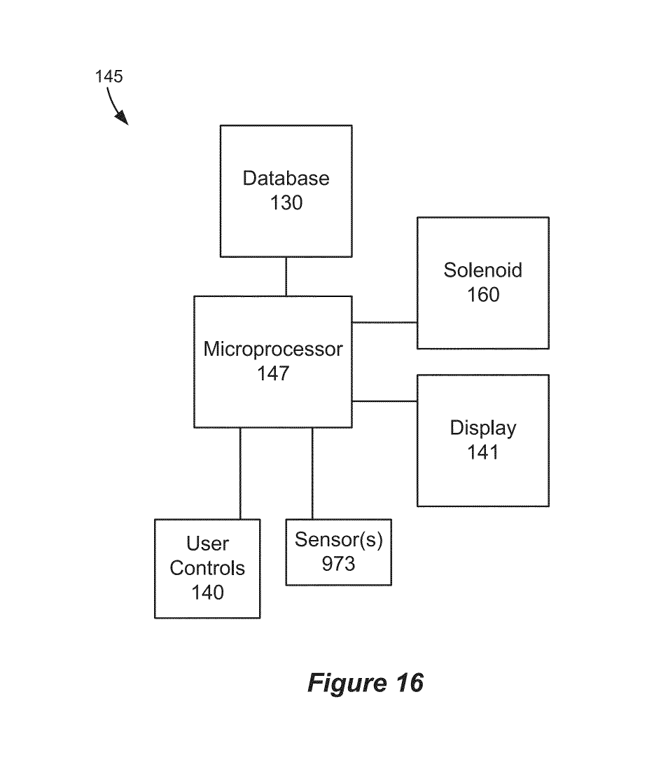

The purge switch 840 controls the amount of the blending gas entering the carafe 701. Purge switch 840 may comprise a momentary switch where the user may control how much blending gas is dispensed by holding down the purge switch 840. Also, the purge switch 840 may be connected to a separate control, for example, a microprocessor 147 (FIG. 16) that automatically dispenses a certain amount of blending gas. Other control mechanisms for the switch 840 are also envisioned such as a digital switch and/or a relay for example. The carafe mount 850 also has a connector dock 820 to connect to the purge system housing 710 and deliver purging control signals and/or power to the purge system housing 710.

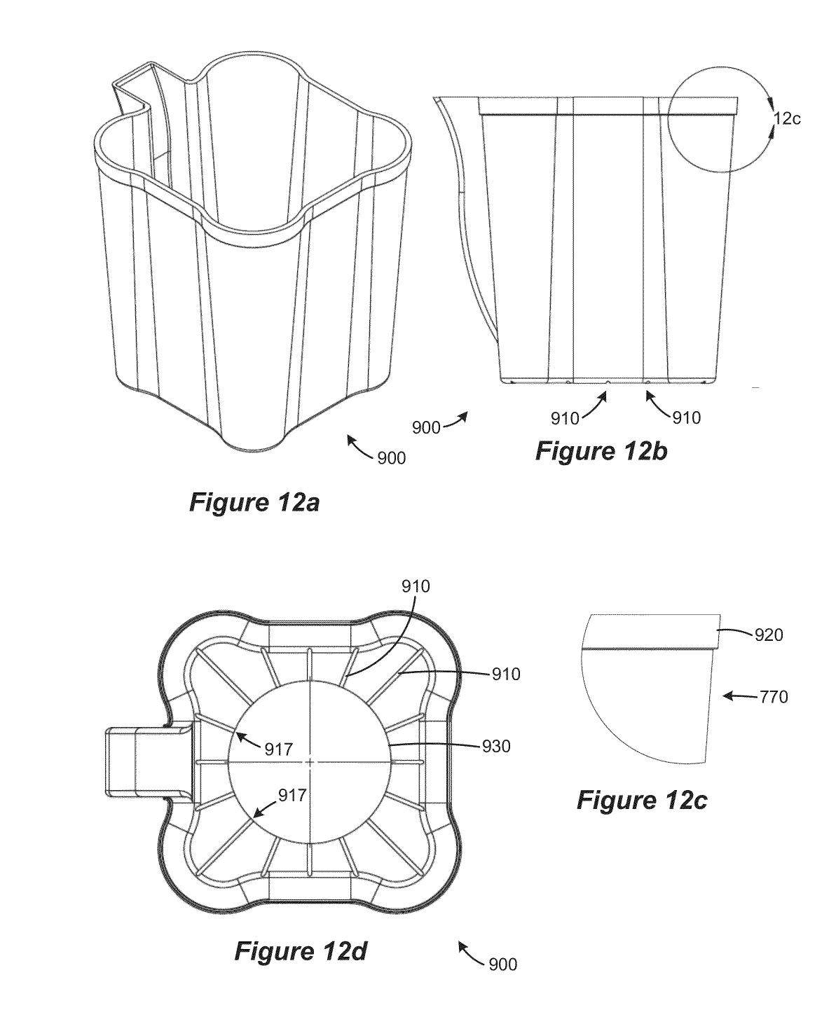

FIG. 9a shows a top view of the carafe 701. FIG. 9b shows a side view of a cross-section of the carafe 701 as noted in FIG. 9a. FIG. 9b also shows a cross-section of an insert 900 inserted into the carafe 701. In some embodiments, the insert 900 may be placed inside the carafe shell 760, while in other embodiments the carafe shell 760 can be used without an insert 900. When the insert 900 is not used, the blending gas will enter the carafe 701 at the top to purge the carafe 701 of air and flow down to settle on the food product to be blended. When the insert 900 is used, it creates an annulus 770 through which the blending gas can flow from the top to the bottom of the carafe 701, causing the blending gas to bubble up through the food product as detailed previously. The insert 900 will be discussed further with respect to FIGS. 12a-12d.

Looking further at the carafe 701 and its features, FIG. 9c shows a front view of carafe 701 with a partial cutaway (FIG. 9d, shows a cross-section of the carafe 701 and purge system housing 710). The purge system housing 710 has a cartridge chamber cover 720, which provides access to the cartridge housing 723 and blending gas cartridge 110 for easy replacement of the cartridge.

When the control signals indicate, a valve or valve solenoid 713 such as that shown in FIG. 9d will open and allow the blending gas to flow from the blending gas source, e.g., CO₂ cartridge 110, to the carafe shell gas inlet connector 765. FIG. 9b shows, in phantom, the location of gas connection passages 717 that are used to connect the purging gas source to the solenoid 713 and from the solenoid 713 to the inlet connector 765. The gas inlet connector 765 is where the blending gas enters the carafe shell 760. Similar to previous embodiments, the carafe 701 has a ridge 780 which contains a manifold 783 along the circumference of the ridge 780 that delivers the blending gas to the inside of the carafe 701.

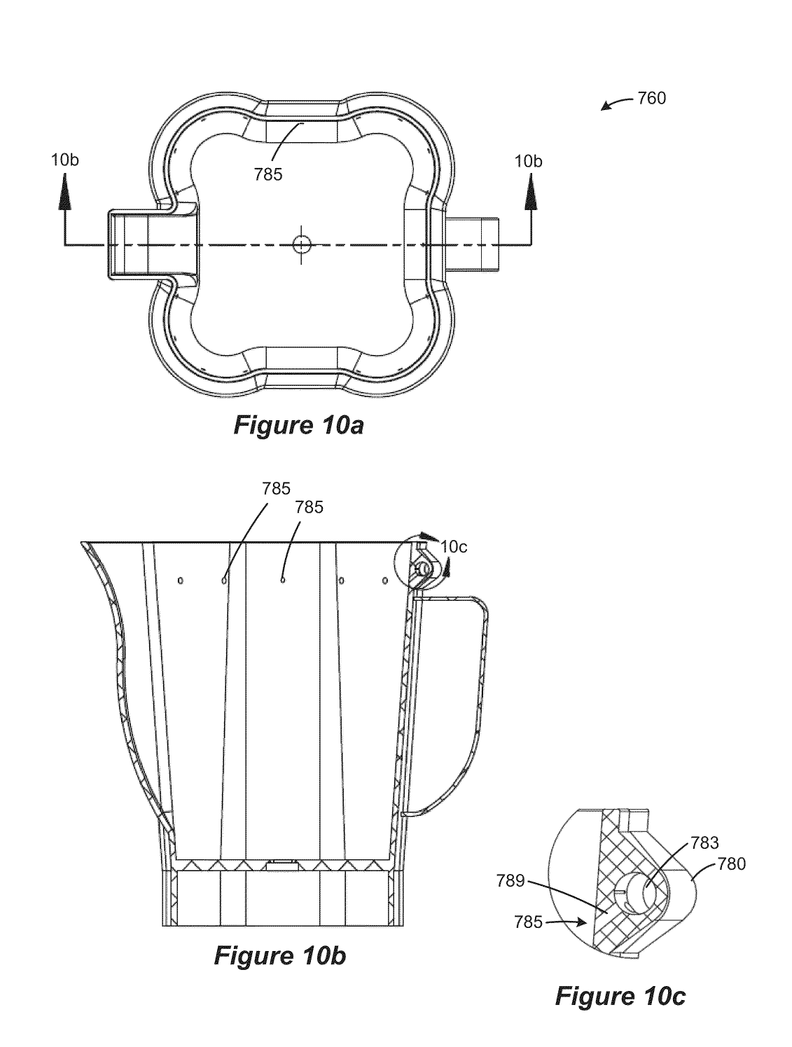

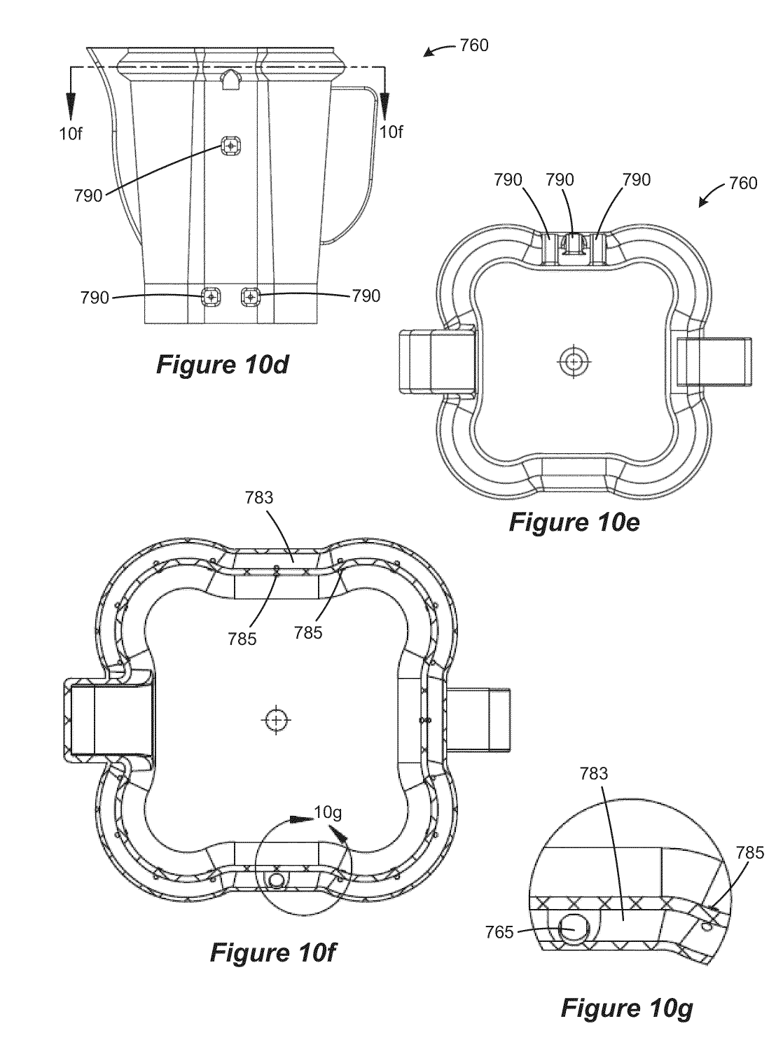

Further details of the carafe shell 760 will now be discussed with reference to FIGS. 10a-10g. FIG. 10a is the top view of the carafe shell 760, FIG. 10b is a cross-section of the carafe shell 760, and FIG. 10c shows detail of the ridge 780. As discussed previously, the blending gas enters the ridge manifold 783 via the inlet connector (765; See FIG. 9d). As shown in FIG. 10b, gas delivery ports 785 line the inside of the carafe shell 760 near the top of the carafe shell 760. As seen in FIG. 10c, the ridge manifold 783 supplies the blending gas to the gas delivery ports 785 via connecting passages 789. When the carafe 701 is used without an insert 900, the blending gas will enter the carafe 701 from the gas delivery ports 785 purging the carafe 701 of air and flowing down to settle on the food product to be blended in a manner similar to that described previously.

FIG. 10d shows a front view of the carafe shell 760 with the purge system housing 710 removed. Revealed are three threaded lugs 790 that marry to matching holes in the purge system housing 710. FIG. 10e is a bottom view of the carafe shell 760. The lugs 790 can be seen protruding out of the front of the carafe shell 760. FIGS. 10f and 10g show a more detailed view of the manifold inlet 765, the ridge manifold 783, and the gas delivery port 785.

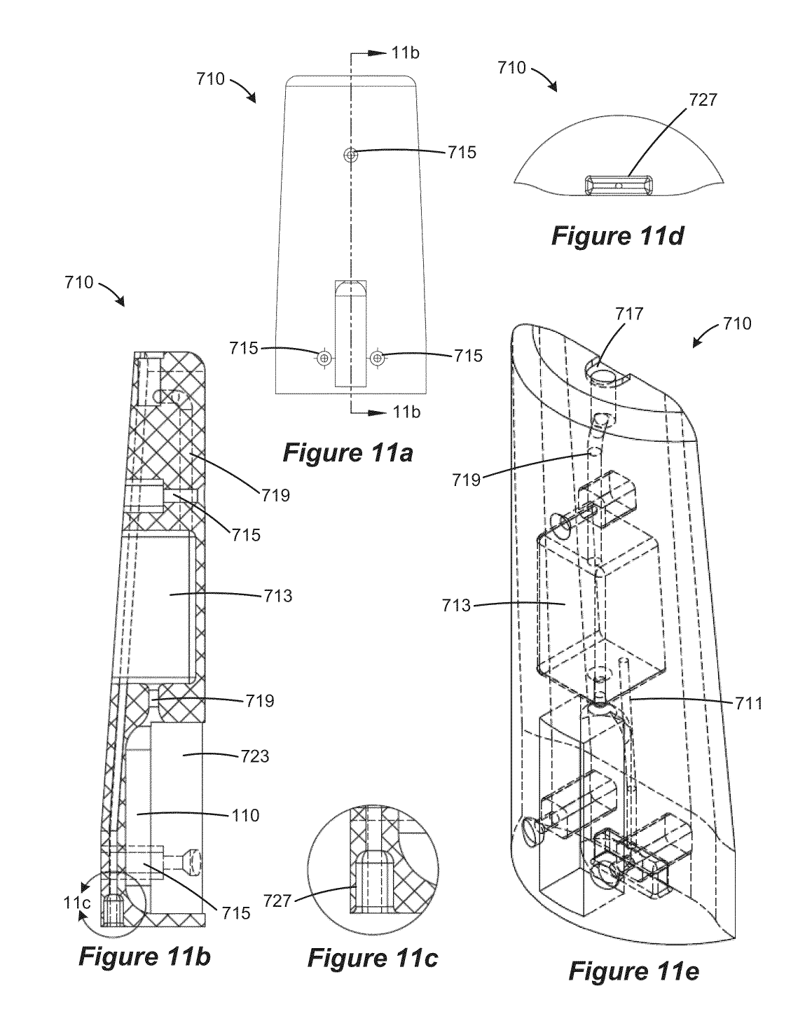

Turning now to additional details of the purge system, FIG. 11a shows a front view of the purge system housing 710. The front of the housing 710 has countersunk holes 715 that open up to the back of the housing 710 to accommodate the lugs 790 of the carafe shell 760. The purge system housing 710 is held into place on the shell 760 by screws (not shown) that enter the front of the housing 710 and screw into the threaded lugs 790.

FIG. 11b shows a cross-section of the purge system housing 710, and FIG. 11c is a detail view of the connector dock 727 shown in FIG. 11b. Dock 727 connects to connector 820 on base 801 to receive the purging control signals. FIG. 11d is a bottom view of the housing 710 showing another view of connector dock 727. FIG. 11e is a plan view of purge system housing 710 with internals shown in phantom. An electrical conduit 711 provides wires from the connector dock 727 to activate the solenoid 713. The top of the purge system housing 710 has a gas connection 717 that connects to inlet (765; FIG. 9d) forming an airtight seal between the housing 710 and the carafe shell 760.

As noted above, the blender 700 can be used with or without an insert 900, which may depend on the type of food product being blended, the user's preference, or other considerations. Further details of the carafe insert 900 are discussed with reference to FIGS. 12a, 12b, 12c, and 12d, which show the carafe insert 900 in plan, side, detailed, and bottom views respectively. Insert 900 may be placed inside the carafe 701 by fitting an aperture 930 formed in the bottom of the insert 900 past the blades (310; FIG. 9d) in the bottom of the carafe 701. The insert 900 once installed in the carafe 701 can then be used to detour the purging gas from the gas delivery ports 785 around the top of the carafe shell 760 to the bottom of the carafe 701 thereby introducing the blending gas into the carafe 701 by bubbling up through the food product to be blended.

As shown previously with reference to FIGS. 9b-9d, the insert 900 is held in place by the lid 750 from above and has a lip 920 that rests on the carafe shell 760 forming an annulus 770 between the insert 900 and the carafe shell 760. With the carafe 900 in place, the blending gas will flow from the gas delivery ports 785 down the annulus 770 and through delivery channels 910 formed in the bottom of the insert 900. These gas delivery channels 910 allow the blending gas to be introduced in the bottom of the carafe through the openings 917 that are formed between the bottom of the insert 900 and the bottom of the inside of the carafe shell 760. The openings 917 are formed in the circumference of the aperture 930 formed in the bottom of the insert 900 to clear the blades (310; FIG. 9d) in the bottom of the carafe 701.

Many variations of the invention will become apparent to those skilled in the art upon review of this disclosure. For example, distinct passages or channels are shown communicating the gas along the carafe. More or less can be used. In addition, the passage or channel may be formed by a space between inner and outer walls of the carafe or can be formed in other ways.

Although shown on the base 801, the purge switch 840 may also be mounted elsewhere on the system creating a standalone carafe (not shown) that comprises a control system built-in to the carafe to control the valve or solenoid 160, 713, thereby allowing the carafe 701 to be retrofitted to be used with a conventional and/or commercially available blender or blender base. For example, the purge switch 840 may be mounted on the purge system housing 710. The purge switch 840 may also be, for example, wired or wirelessly mounted on the lid 750, or the handle 730.

Additionally, the standalone carafe system may be made to rely partially or completely on mechanical systems alone. For example, push-buttons and springs may be used to control the flow of gas into the carafe 701.

In one embodiment, the carafe handle (e.g., handle 730) has a thumb switch (not shown) which while pressed allows purge gas to flow into the carafe 701. In one example, the user could control the amount of gas used by counting a number of seconds to ensure adequate gas flow into the carafe 701.

Other embodiments could use wall power or battery power to control the purging timer, the solenoid 160, and other control devices (e.g., controller 145). The standalone carafe or other embodiments described may also comprise a pressure indicator or other form of gas-level indication, as well as an indicator of available battery power, e.g., on a touch screen or LCD display 141 (FIG. 16). The indications may be quantified as a percentage, a value (pounds per square inch, for example), or the number of remaining purging cycles capable of being performed.

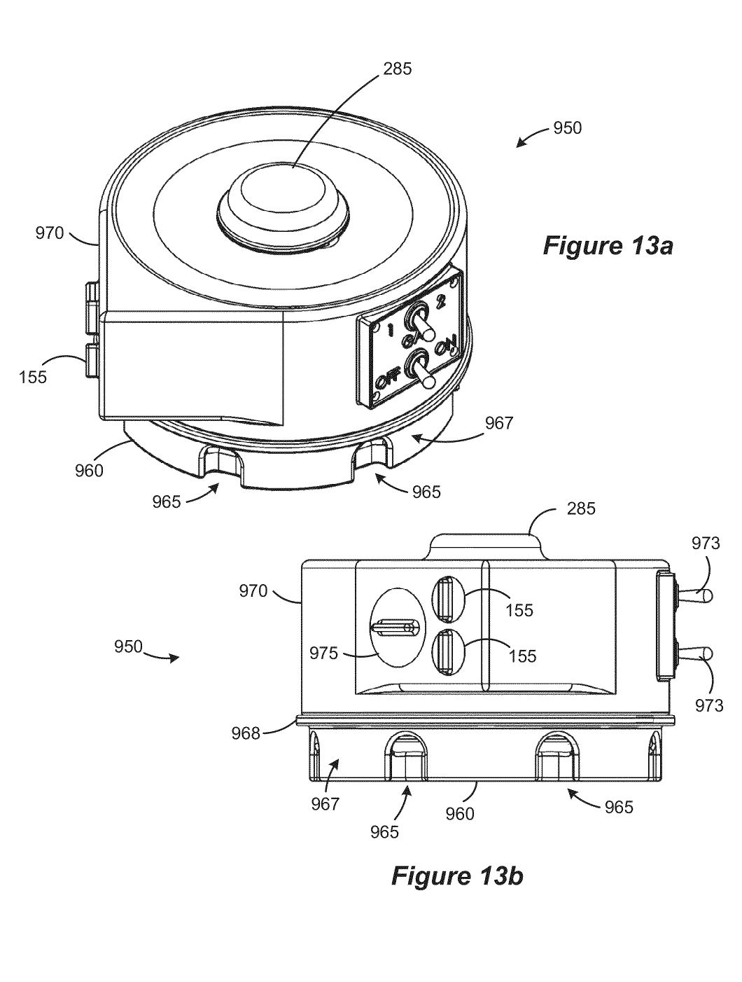

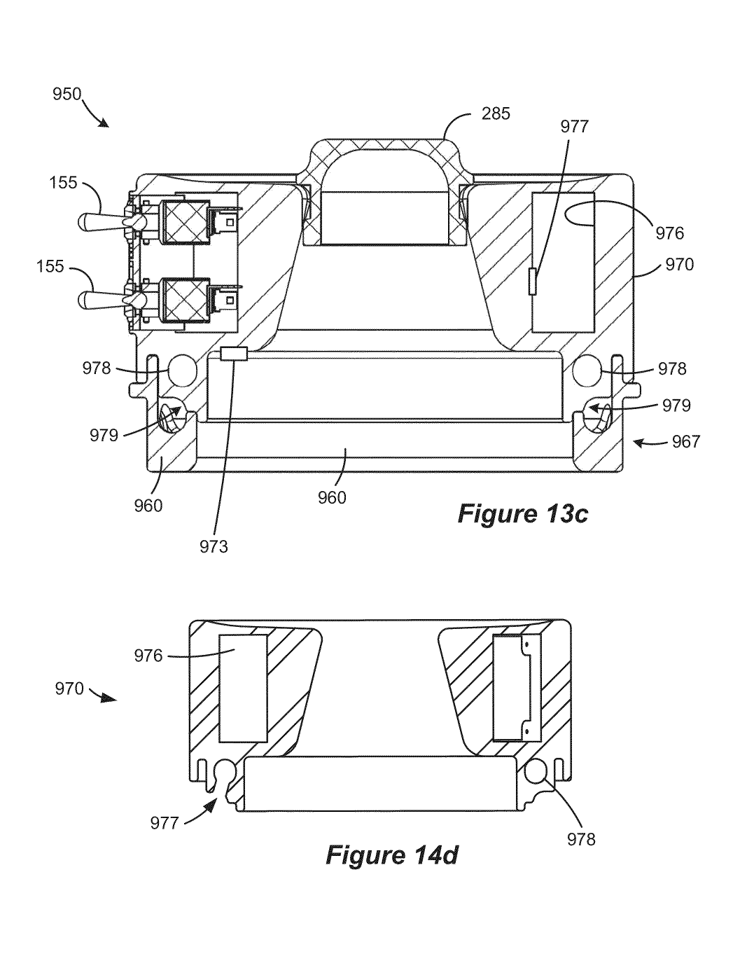

In previous embodiments, features of the purging system have been disclosed as being used on the base, the carafe, and the lid of the appliance 50 in various ways and combinations. As an alternative, a standalone lid 950 as described below with reference to FIGS. 13-15 can be used with a carafe of a blender. In particular, FIGS. 13a-13c show the standalone lid 950 which may comprise a main body 970, a mating flange 960, and an ice port lid 285. These components may be separable, e.g., to facilitate ease of washing and maintenance. Additionally, these components may be made to fit together by use of friction or threaded flanges, for example, or compression fittings and the like.

In one embodiment, the standalone lid 950 is a purging lid for a blending container, such as a carafe. The purging lid has a body configured to be fitted over the open end of the container for sealing food product within the container. The body has contained therein a pressured gas source and at least one gas passageway for delivering pressured gas from the gas source to the blending container. The gas passageway extends through at least one chamber in the lid 950. The chamber is in fluid communication with a plurality of exit ports configured to deliver the blending gas to the food product in the blending container coupled to the lid 950.

As specifically shown, the standalone lid 950 comprises its own gas delivery system, described further below, and may be sized, shaped, and spaced to connect to a blender carafe (not shown). The blender carafe may be one of a number of commercially available blenders and carafes thus allowing the standalone lid 950 to be retrofitted with previously known blenders.

As with the carafe 701 described above, the standalone lid 950 may be actuated, for example, by mechanical controls with manual flow control. The blending gas may flow through various passages and/or gas tubes and flow into an attached blender carafe via exit ports 965.

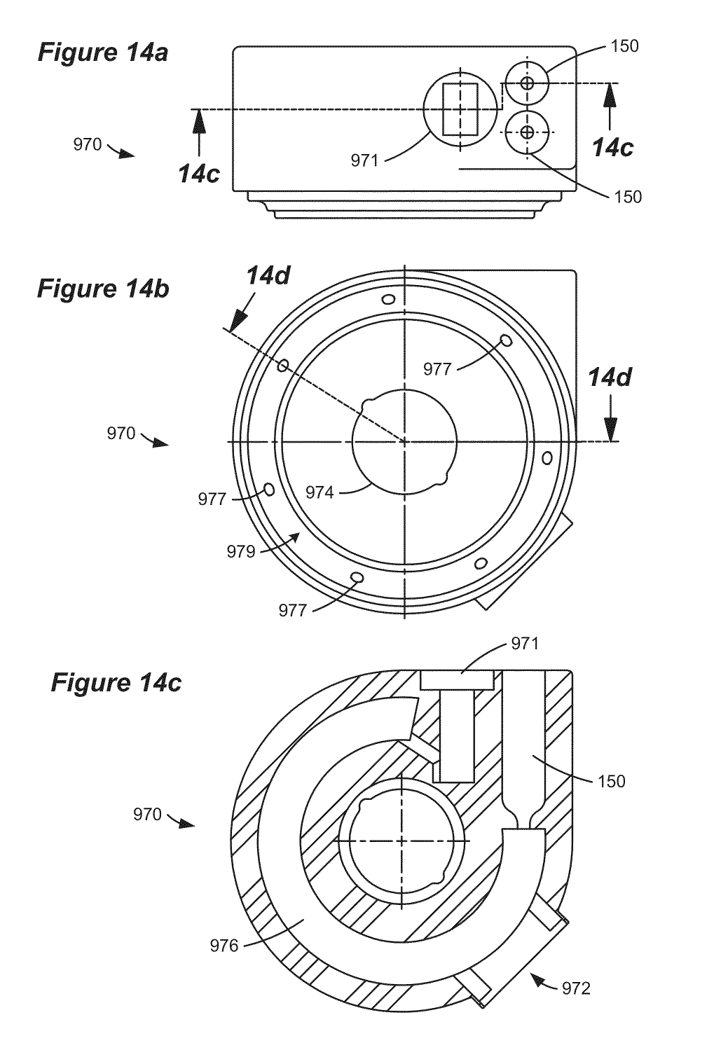

The main body 970 may be a molded piece comprising two gas ports 150 (FIGS. 14a, 14c) that allow, for example, compressed gas cylinders 110 (not shown) to be installed and held in place by retainers 155. Ports 150 may be used to install cylinders or external gas sources of one or more types so that the blending gas may be switched between the two gas sources based on the user's need. For example, one may not want to carbonate their pesto, so in addition to having a CO₂ cylinder, a user may also have an argon or nitrous oxide (N₂O) cylinder installed for this purpose. In other embodiments, the standalone lid 950 may blend the gasses in a pre-determined ratio. For example, it may be desirable to blend a food product with a small amount of first gas (e.g., one that is relatively expensive). A second gas may be dispensed at the same time to purge the carafe of air, but not fill the carafe with all of the first gas. In another embodiment, the two gasses are dispensed sequentially by a controller 145 and thus the mix of the gasses determined by the time each one is flowed. As will be appreciated, use of the two gas sources in the present embodiment of the standalone lid 950 can be comparably used in other embodiments disclosed herein so that the base 100 of FIGS. 1a-1d, the purge system 710 of FIGS. 7a-7d, and other arrangements disclosed herein can include more than one gas source in a similar manner.

For controlling the amount of gas flowed into the blending carafe during each use, the standalone lid 950 may use an electrically powered solenoid 160 coupled to the controller 145, for example, powered by batteries or wall power. The amount of gas used may be controlled by various means. For example, the standalone lid 950 may comprise a pressure transducer (e.g., 977; FIG. 13c) to measure the pressure drop of the gas cartridge 110.

Other methods may also be used to control the gas flow. For example, the standalone lid 950 may comprise a controller 145 coupled to the solenoid 160. The controller 145 may comprise a timer to limit the gas flow by measuring time of flow. Additionally, the standalone lid 950 may comprise an oxygen sensor (e.g., 973; FIG. 13c) coupled to the controller 145 for measuring the oxygen content of the gas in the carafe. In one embodiment, the controller 145 opens the solenoid 160 releasing the blending gas until the oxygen level in the carafe drops to a predetermined value after which the controller 145 may automatically close the valve.

Other sensors 973, 977, etc. may be deployed for this purpose, such as pressure sensors or flow monitors (not shown) that measure for a certain pressure drop or flowed amount of gas to dictate the on/off state of the valve or solenoid. Another sensor 973 that may be used to control the amount of gas to use is a waterproof ultrasonic sensor. This sensor 973 may be mounted on the underside of the lid, for example, to determine the distance from the lid to the top of the food product. A volume of blending gas can then be calculated based on the size and shape of the intended carafe. A database 130 comprising carafe shapes and sizes for making this determination may be stored in the controller 145 in some embodiments.

As may be seen in FIGS. 14a-14d, a battery storage area 971 may hold a battery for a supplying power to the standalone lid 950. The battery storage area 971 may be kept water tight by a plug (975; FIG. 13b) in similar manner as retainer 155. Within the main body 970 may be a channel 976 that may be used to house gas tubing, wire, check valves, a pressure regulator, and a solenoid (not shown). A face plate with switches 973 may be mounted on a front opening 972 of the main body 970. Switches 973 may be toggle switches, momentary switches, blister buttons, radio buttons, or the like and may be used, for example, to select the blending gas (when more than one canister is provided) and to actuate the gas flow.

A touch screen display e.g., 141; FIG. 16 may also comprise the face plate and user controls 140. In one embodiment, the touch screen display l41is a menu-driven display to operation of the user controls 140 as well as display of other pertinent data such as pressure indications or other forms of gas-level indications and battery power indications. The database 130 may also comprise food product references and blending gas recommendations. Using the database 130, the display 141 may also provide the recommendations for the type of gas to be used on different food products. In some embodiments, the controller 145 may comprise a microprocessor 147 and the display 141. The type of carafe used (e.g., size, shape, brand, etc.) may be selected from the display.

The front opening 972 may be used as an access area to provide for a simplified assembly. An opening 974 in the top of the main body 970 is sized and spaced to accommodate an ice port lid 285. This allows for the introduction of ice or other products to a carafe (not shown) fitted below the standalone lid 950 before, during, or after the blending process is underway. In an embodiment, the main body 970 or ice port lid 285 may also comprise a relief valve or seal, similar to that described previously. The channel 976 may be connected by a small molded gas channel (not shown) or by gas tubing (not shown) to the main body gas ring 978.

Passage holes 977 (FIG. 14b) in the main body gas ring 978 provide a route for the gas to exit the main body 970 and into a gas delivery passage 979 that is formed when the main body 970 is attached to the mating flange 960 as may be seen in FIG. 13c.

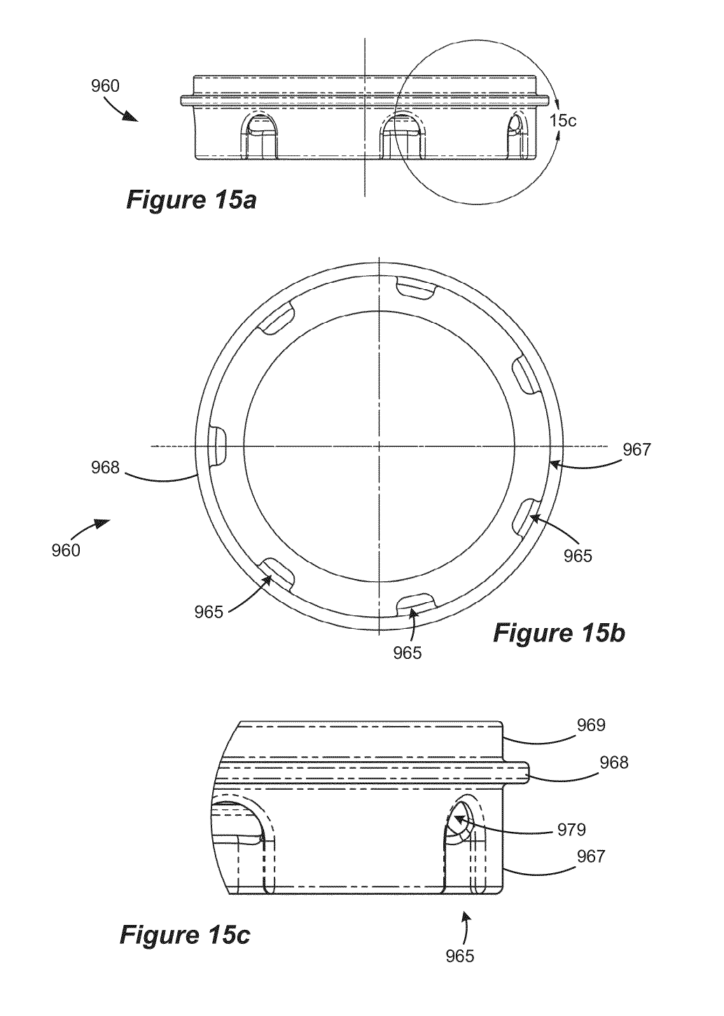

The mating flange 960 may attach to the top of a common or commercially available blender carafe (not shown) via a carafe sealing face 967. In this way, the mating flange 960 may fit on top of and inside the upper opening of the blender carafe such that the carafe sealing face 967 of the mating flange 960 provides a seal between the mating flange 960 and the blender carafe. Exit ports 965 (FIGS. 15a-15c) in the carafe sealing face 967 provide gas communication channels between the carafe and the gas delivery passage 979. The sealing face 967 may also be formed to have a relief passage (not shown) to provide a channel for pressure in the carafe to escape. In an embodiment, the relief passage comprises at least a portion of a pouring spout (not shown) on the carafe.

The mating flange 960 may also comprise a main body sealing face 969. The main body sealing face 969 is sized and shaped to couple the mating flange 960 to the main body 970. Although shown as a friction fitting, the main body sealing face may attach to the main body 970 in other ways, for example, matching threads on the main body 970 and the mating flange 960. A stop or lip 968 may separate the main body sealing face 969 from the carafe sealing face 967. The main body 970 and mating flange 960 may be made in such a way that the blending gas communicates down to the carafe without food products communicating back up into the gas ring 978. For example, the passage holes 977 may be offset from the exit ports 965. Additionally, the lid 950 could use baffle plates (not shown) to prevent backflow of food products that may be splashed upward.

As shown in FIGS. 15a-15c the mating flange 960, carafe sealing face 967, and the main body sealing face 969 are round, however they may be made in different shapes. In particular, a number of mating flanges may be provided to a user with the same main body sealing face 969 but having different shaped carafe sealing faces. This will allow the standalone lid 950 to be used with different carafe styles. In another embodiment, the carafe sealing face 967 of the mating flange 960 could also be made such that it elongates at various or variable lengths into the carafe, and/or submerges into the foods mixture to be blended.

These embodiments may be combined with some of the features previously described. For example, carafe inserts 400, 900 can be made to have openings that line up with the exit ports 965 of the mating flange 960 to help move the blending gas deeper into the blender, etc.

The foregoing description of preferred and other embodiments is not intended to limit or restrict the scope or applicability of the inventive concepts conceived of by the Applicant. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A blender appliance for delivering a gas from a gas source to a food product, the appliance comprising:
a body comprising a container mount and a gas delivery channel, the container mount mountable to a container for the food product, the gas delivery channel connecting the gas source to at least one outlet passage on the body for communicating the gas from the gas source to the container;
a valve in fluid communication with the gas source and being actuatable to regulate delivery of the gas through the gas delivery channel; and
a controller operatively coupled to the valve for actuating the valve.

2. The appliance of claim 1, wherein the appliance includes the container, the container comprising:
a fitting for receiving the gas from the at least one outlet passage; and
a container delivery passage in fluid communication with the fitting and comprising at least one container outlet passage, the at least one container outlet passage in fluid communication with an inside of the container.

3. The appliance of claim 2, wherein the at least one container outlet passage is directed toward the food product and positioned proximate to an inner wall of the container to promote laminar flow of the gas.

4. The appliance of claim 2, further comprising a container insert positioned in the container, the insert defining gas transport channels running a length of the container to communicate the gas to the food product.

5. The appliance of claim 4, wherein the gas transport channels comprise exit ports proximate to a bottom of the container for delivering the gas at least partially underneath the food product.

6. The appliance of claim 2, wherein the container delivery passage runs a length of the container, wherein the fitting for receiving the gas from the at least one outlet passage is located at a bottom of the container, wherein the container delivery passage is configured to deliver the gas to a top of the container.

7. The appliance of claim 6, wherein the fitting comprises an opening into a chamber formed at a bottom of the container when the container is mounted with the container mount to the body.

8. The appliance of claim 6, wherein a handle of the container comprises the container delivery passage.

9. The appliance of claim 1, wherein the appliance includes the container, wherein the container mount comprises lugs or lug holes, the lugs or lug holes used to secure the body to the container, the container comprising a fitting for receiving the gas from the at least one outlet passage.

10. The appliance of claim 1, wherein the container mount comprises a mating flange disposed on the body, the mating flange comprising:
a main body sealing face for at least partially sealing the flange against the body; and
a container sealing face for at least partially sealing the flange against a container.

11. The appliance of claim 10, wherein the mating flange is removable from the body.

12. The appliance of claim 10, wherein the mating flange comprises a plurality of exit ports for creating a plurality of gas exit channels when at least partially sealed against the container.

13. The appliance of claim 1, wherein the gas delivery channel encompasses a circumference of the container.

14. The appliance of claim 1, wherein the controller comprises an electrical switch.

15. The appliance of claim 14, wherein the controller further comprises a microprocessor.

16. The appliance of claim 1, wherein the controller comprises a physical valve switch mechanically operating the valve.

17. The appliance of claim 1, wherein the controller comprises a microprocessor and a display operatively coupled to the microprocessor, the actuation of the valve controllable from the display.

18. The appliance of claim 17, wherein the microprocessor comprises a database of container sizes.

19. The appliance of claim 1, wherein the controller comprises a timer for defining a time span in which the gas is delivered from the gas source to the at least one outlet passage.

20. The appliance of claim 1, further comprising:
a second gas delivery channel connecting a second gas source to the at least one outlet passage on the body; and
a second valve in fluid communication with the second gas source and being actuatable to regulate delivery of the second gas through the second gas delivery channel,
wherein the controller is operatively coupled to the second valve for actuating the second valve.

21. The appliance of claim 1, wherein the gas comprises one or more of the following: an inert gas, a gas that is heavier than air, carbon dioxide, argon, nitrogen, or nitrous oxide.

22. The appliance of claim 1, wherein the appliance is operable to displace air surrounding and/or above the food product in the container with the gas and/or blend the gas with the food product in the container.

23. The appliance of claim 1, wherein the body comprises a base on which the container mounts.

24. The appliance of claim 1, wherein the body comprises a lid configured to fit on an open end of the container.

25. The appliance of claim 1, wherein the body affixes to the container.

26. A method for processing a food product in a container with a gas from a gas source, the method comprising:
delivering the gas to the container from a body, the body comprising a container mount and a gas delivery channel, the container mount mountable to the container, the gas delivery channel connecting the gas source to at least one outlet passage on the body for communicating the gas from the gas source to the food product;
regulating delivery of the gas from the gas source through the gas delivery channel by controlling a valve in fluid communication with the gas source; and
at least displacing air above the food product with the delivered gas.

27. The method for processing a food product of claim 26, further comprising blending the food product in an interior of the container.

28. The method for processing a food product of claim 26, wherein delivering the gas to the container comprises receiving the gas into the interior of the container while blending the food product.
